(19) United States
(12) Patent Application Publication
(10) Pub. No.: US 2020/0134622 A1
(43) Pub. Date: Apr. 30, 2020

(54) METHODS AND SYSTEMS FOR CONTROLLING AND MONITORING TOKEN SPEND

(71) Applicant: JPMorgan Chase Bank, N.A., New York, NY (US)

(72) Inventors: Sangameswara Rao PANCHOMARTHI, Baer, DE (US); Monish PINGLE, Mumbai (IN); Parth K. PATEL, Mumbai (IN); Vinish PILLAI, Mumbai (IN); Rajini KAKARLA, Bear, DE (US); Domerick Dingming CHOI, Newark, DE (US)

(21) Appl. No.: 16/669,778

(22) Filed: Oct. 31, 2019

Related U.S. Application Data
(60) Provisional application No. 62/753,266, filed on Oct. 31, 2018.

(51) Int. Cl. G06Q 20/40; G07F 17/32; G06Q 20/10

(52) U.S. Cl. CPC G06Q 20/405; G06Q 20/10; G07F 17/3237

(57) ABSTRACT

An embodiment of the present invention is directed to applying token spend controls. A mobile device comprises a microprocessor, coupled to a memory component and an interface, configured to perform the steps of: identifying a payment card associated with the mobile device; generating a unique token based at least in part on a combination of the payment card and the mobile device; identifying one or more spend limits and controls placed on the payment card that is specific to an authorized user of the payment card; tracking the payment card usage by the authorized user; generating and displaying, via the interactive user interface, the payment card usage; and providing a notification when the payment card usage exceeds the one or more spend limits and controls.

### CROSS REFERENCE TO RELATED APPLICATIONS

The application claims priority to U.S. Provisional Application 62/753,266 (Attorney Docket No. 72167.001484), filed Oct. 31, 2018, the contents of which are incorporated herein in its entirety.

### FIELD OF THE INVENTION

The invention relates generally to a method and a system for provisioning and controlling spend for tokens based on a card product and user device combination.

### BACKGROUND OF THE INVENTION

Credit cards are being tokenized on many mobile devices and electronic wallets for digital payments. For example, an electronic wallet (e.g., Apple Pay, etc.) may provision a token for a particular payment card and a specific mobile device. When a purchase is made at a point of sale (PoS), the token may be mapped to a customer's payment card number. Under this payment scenario, a customer is not required to share a payment card number with a merchant or other third party. However, with this payment option, there is no currently no mechanism to provide any controls or limits on use of the payment card.

These and other drawbacks exist.

### SUMMARY OF THE INVENTION

According to one embodiment, the invention relates to a system that provisions and controls token spend. A mobile device comprises: a memory component that stores user spend data; an interactive interface that receives user input and communicates via a communication network; and a microprocessor, coupled to the memory component and the interactive interface, configured to perform the steps of: identifying a payment card associated with the mobile device; generating a unique token based at least in part on a combination of the payment card and the mobile device; identifying one or more spend limits and controls placed on the payment card that is specific to an authorized user of the payment card; tracking the payment card usage by the authorized user; generating and displaying, via the interactive interface, the payment card usage; and providing a notification when the payment card usage exceeds the one or more spend limits and controls.

According to another embodiment, the invention relates to a method that provisions and controls token spend. The method comprises the steps of: identifying, via a microprocessor, a payment card and a user device that is associated with the payment card; generating a unique token based at least in part on the payment card and the user device; identifying one or more spend limits and controls placed on the payment card that is specific to an authorized user of the payment card; tracking the payment card usage by the authorized user; generating and displaying, via an interactive user interface, the payment card usage; and providing a notification when the payment card usage exceeds the one or more spend limits and controls.

The various embodiments of the present invention may be implemented on a specially programmed computer system comprising one or more computer processors, interactive interfaces, electronic storage devices, and networks.

The computer implemented system and method described herein provide unique advantages to customers, businesses and other users, according to various embodiments of the invention. The innovative system and method provide a customer the ability to track and manage spend controls for tokens. This is particularly useful when a single card is used by multiple customers, e.g., family, small business, etc. The various embodiments of the present invention provide flexibility and control while enhancing the ability to track and prevent fraudulent and unauthorized card use. These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary illustration of a user interface, according to an embodiment of the present invention.

FIG. 2 is an exemplary illustration of a user interface on a mobile device, according to an embodiment of the present invention.

FIG. 3 is an exemplary illustration of a system for implementing token spend controls, according to an embodiment of the present invention.

FIG. 4 is an exemplary flowchart of a method for implementing token spend controls, according to an embodiment of the present invention.

### DETAILED DESCRIPTION OF THE PREFERRED EMBODIMENT(S)

The following description is intended to convey an understanding of the present invention by providing specific embodiments and details. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

An embodiment of the present invention is directed to monitoring and controlling spend on mobile devices, electronic wallets and other payment instruments. Tokens are unique per device or per electronic wallet. An embodiment of the present invention is directed to controlling spend limit on a per device, merchant, wallet or other basis.

With an embodiment of the present invention, a credit card owner may give someone, e.g., family member, use of the credit card while retaining an ability to control and manage the spend. For example, a credit card owner may control spend and use for various other users. Other users may include family member (e.g., spouse, children, parents, extended family members, etc.), employees (e.g., workers, nanny, assistant, contractors, etc.) and users of other devices. For example, a parent may share a payment card with a child. In this example, the parent's mobile device is associated with the payment card and the child's mobile device is also associated with the same payment card. Accordingly, each device may generate a unique token based on a unique payment instrument and mobile device combination.

An embodiment of the present invention is directed to smart device token level controls. The innovative system may control various aspects of card use. This may include daily spend limit, monthly spend limit and/or other time period. Other controls may be placed on time and/or day based spending. In addition, controls may be placed on a schedule, e.g., weekdays but not weekends. Other various controls based on specific uses and applications may be applied. For example, an embodiment of the present invention may limit and/or control based on merchant, type of purchase (e.g., school related purchases), location of purchase, proximity of purchase, customer schedule/plans, etc.

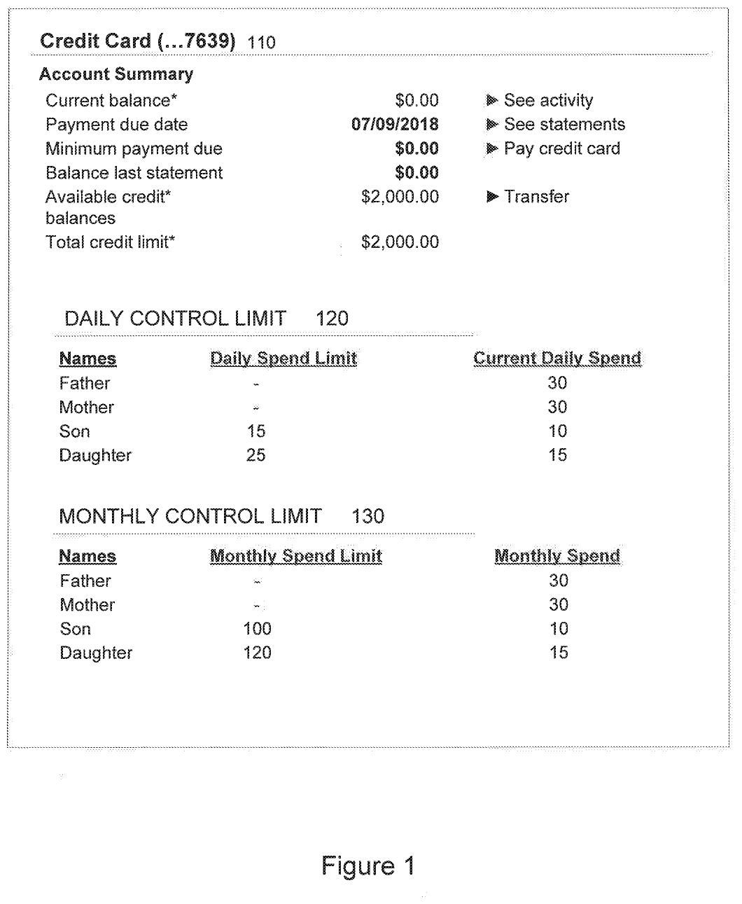

FIG. 1 is an exemplary illustration of a user interface, according to an embodiment of the present invention. FIG. 1 is an exemplary user interface that may be accessible by a website. As shown in FIG. 1, account summary information may be provided at 110. A card holder may view and modify various controls associated with the user of the payment card. In this example, a credit card summary is provided. Other payment instruments may be managed, including debit cards, loyalty cards, etc. As shown in FIG. 1, a user may control daily limits at 120 as well as monthly limits at 130. The names or identifiers of associated and authorized users may be provided along with daily spend limits and current daily spend information. Likewise, for monthly control limits, names or identifiers and associated monthly spend limits and monthly spend may be provided. Other aspects of the payment card may be controlled, monitored and managed. For example, for a son or daughter, a parent may apply other restrictions, including time of use, zones, approved merchants or merchant types, transaction types, etc.

The system may also provide alerts or notifications when there is a questionable transaction. If an authorized user attempts to make a transaction that is restricted, a parent or other user may be notified of the attempt. If the user is in an emergency situation or a specific need is justified, the parent may lift the restriction and allow the transaction. If this type of transaction is repeated, an embodiment of the present invention may recommend an adjustment in the restriction to allow future similar transaction under similar circumstances. Alerts or notifications may also be provided for fraudulent and suspicious charges.

An embodiment of the present invention may apply control zone restrictions. Control zones may designate an approved geographic (or other area of approved use) that indicates that purchases made within the zone are authorized while denying purchases made outside of the control zone. The control zone may be identified by a user or automatically identified based on historical data of approved and authorized purchases. The control zone may be city specific, zip code based and/or otherwise determined by the customer. An embodiment of the present invention may learn a user's spend and other behavior and accordingly adjust a control zone restrictions. Other behavior may be observed and adjusted accordingly. An embodiment of the present invention may apply artificial intelligence, machine learning and/or neural networks to learn and observe customer behavior and identify a corresponding response, recommendation and/or action.

For example, the customer may apply a travel alert prior to a vacation that indicates to the system that purchases made in a new city should be authorized. The customer may also place a time restriction, e.g., end date of travel.

According to another example, if a customer loses or temporarily misplaces the card, the customer may monitor and control spend and further determine if the card was lost or stolen. According to another example, if a customer's spouse is traveling and misplaces the mobile device while on travel, the customer may place a restriction that indicates purchases made in the particular geographic location should be denied. However, the customer may approve necessary transactions, such as hotel and travel. For example, if a card is lost but still active, an embodiment of the present invention may request a travel companion's approval (e.g., spouse's approval) before any purchase. Other safeguards and restrictions (e.g., location verification, type of purchases, etc.) may be applied.

A business owner, for example, may place limits on employees in making purchases and authorizing transactions. In this example, the business owner may place a $500 limit on each employee on a month-to-month basis. The business owner may place other restrictions, including approved merchants, vendors, uses, etc. The restrictions may be business specific. For example, a restaurant owner may approve all food related purchases while denying anything outside of the food industry. This would automatically deny other purchases, such as home electronic transactions.

According to another example, the system may mange and track promotional offers and other rewards. For example, an embodiment of the present invention may be leveraged to provide rewards, promotional offers and other incentives for making token-based purchases at various categories, e.g., gas stations, grocery stores, shopping malls, etc. and/or specific locations. This offering may be controlled by a user where the user may self-activate for a time period, e.g., quarter, month, or other user defined or selected time frame. In addition, this feature allows a user to set specific offers for family members where the offers may be activated based on a preferred category and prior spending patterns at these (and similar/related) merchants to earn rewards. Other variations may be supported.

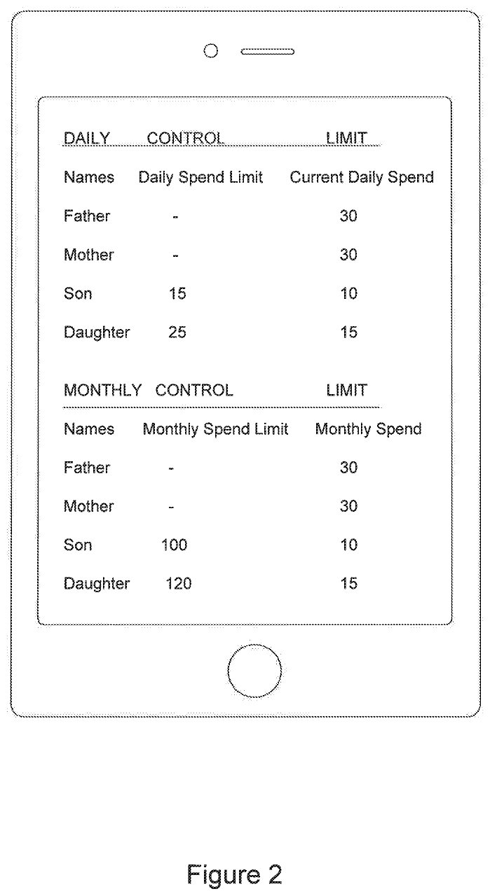

FIG. 2 is an exemplary illustration of a user interface on a mobile device, according to an embodiment of the present invention. As shown in FIG. 2, a user may view control limits, similar to information shown by FIG. 1. Other user devices may support the various features of an embodiment of the present invention. For example, user devices may include tablet devices, wearables, smart devices, mobile devices, etc. In addition, the information may be provided on various third party devices, including kiosks, point of sales, ATM devices, bank teller and/or other interactive devices.

Based on user input, an embodiment of the present invention may provide recommendations, suggestions for optimal control and limits based on user preferences, goals, as well as business rules, etc. The system may identify family travel and then suggest or automatically apply restrictions, permissions, safe zones, etc. In this example, an embodiment of the present invention may approve travel related transactions, e.g., hotel, car rental, transportation in destination city, entertainment, etc. In addition, the system may deny all transactions made at or near the customer's home location.

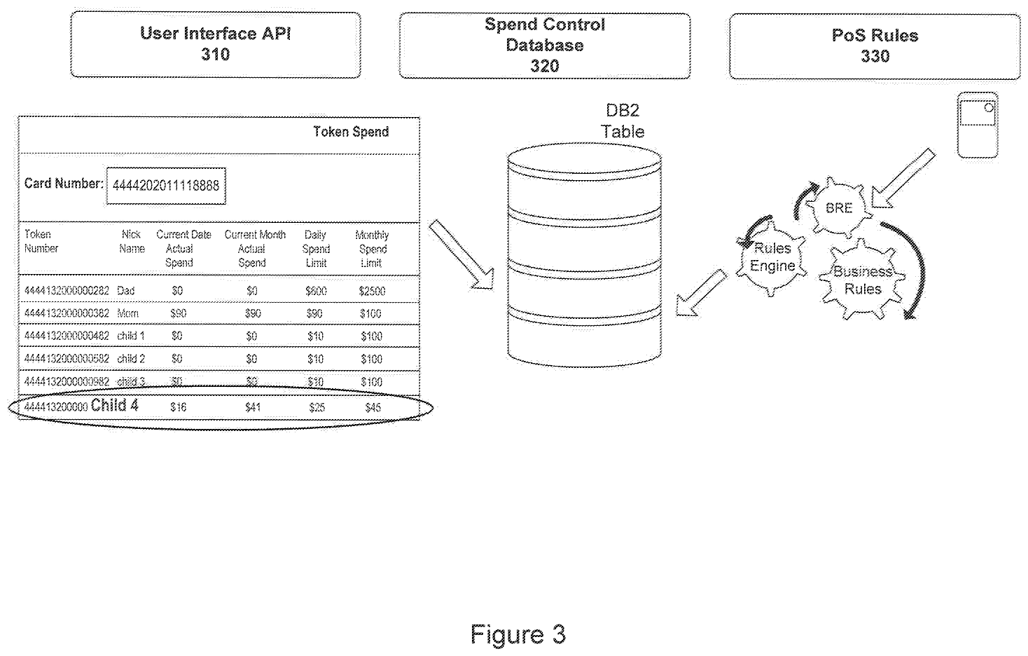

FIG. 3 is an exemplary illustration of a system for implementing token spend controls, according to an embodiment of the present invention. User Interface API 310 may be communicatively coupled to Spend Control Database 320. Spend Control Database 320 may implement PoS Rules 330. Spend Control Database may represent a Token Profile Database that maintains spend limits and spend to date. PoS Rules may represent spend control rules. PoS Rules may be execute business rules via Business Rule Engine (BRE) and other rules via a Rules Engine. An embodiment of the present invention may consider fraud considerations by then adjusting controls based on fraud severity and riskiness.

Spend Control Database 320 may manage spend control data. The spend control data may be organized by token number, customer identifier, actual spend, current date actual spend, current month actual spend, daily spend limit and monthly spend limit. Other restriction data may be applied and managed in a similar manner.

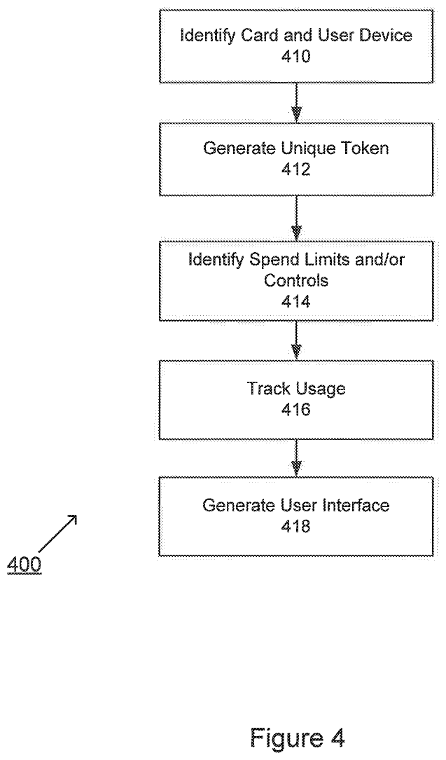

FIG. 4 is an exemplary flowchart of a method for generating a Branch Health Index score, according to an embodiment of the present invention. At step 410, a payment card and user device may be identified. At step 412, a token may be generated. At step 414, spend limits and other controls may be identified. At step 416, the system may track spend usage. At step 418, a user interface may be generated that displays spend usage and/or other metrics. The order illustrated in FIG. 4 is merely exemplary. While the process of FIG. 4 illustrates certain steps performed in a particular order, it should be understood that the embodiments of the present invention may be practiced by adding one or more steps to the processes, omitting steps within the processes and/or altering the order in which one or more steps are performed. Each step will be described in more detail below.

At step 410, a payment card and user device may be identified. The payment card may represent a credit card, debit card, electronic wallet and/or other electronic payment mechanisms. The user device may represent a mobile phone as well as any device that executes an application that enables a payment or other transaction.

At step 412, a token may be generated. The token may be a unique token based on a combination of the payment card and the user device.

At step 414, spend limits and other controls may be identified. Spend limits may represent dollar amount thresholds, number of transaction, geographic areas, time restrictions, etc.

At step 416, the system may track spend usage. Usage may include transactions as well as other interactions with readers, kiosks and other devices.

At step 418, a user interface may be generated that displays spend usage and/or other metrics. The user interface may be provided on a mobile device, desktop device, etc. The user interface may also provide recommendations and suggestions based on the usage data for improved convenience and protection.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

As described above, the system may include a number of servers and user communication devices, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

Data and information maintained by the servers may be stored and cataloged in one or more databases, which may comprise or interface with a searchable database and/or a cloud database. The databases may comprise, include or interface to a relational database. Other databases, such as a query format database, a Standard Query Language (SQL) format database, a storage area network (SAN), or another similar data storage device, query format, platform or resource may be used. The databases may comprise a single database or a collection of databases. In some embodiments, the databases may comprise a file management system, program or application for storing and maintaining data and information used or generated by the various features and functions of the systems and methods described herein.

As described above, a set of instructions is used in the processing of various embodiments of the invention. The servers may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, and/or JavaScript. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

What is claimed is:

1. A mobile device for applying token spend controls, the mobile device comprising:
a memory component that stores user spend data;
an interactive interface that receives user input and communicates via a communication network; and
a microprocessor, coupled to the memory component and the interactive interface, configured to perform the steps of:
identifying a payment card associated with the mobile device;
generating a unique token based at least in part on a combination of the payment card and the mobile device;
identifying one or more spend limits and controls placed on the payment card that is specific to an authorized user of the payment card;
tracking the payment card usage by the authorized user;
generating and displaying, via the interactive interface, the payment card usage; and
providing a notification when the payment card usage exceeds the one or more spend limits and controls.

2. The mobile device of claim 1, wherein the spend limit comprises a dollar amount limit on spend for a predetermined time period.

3. The mobile device of claim 2, wherein the predetermined time period comprises one of: one day, a week, and a month.

4. The mobile device of claim 1, wherein the notification is communicated to one or more authorized recipients.

5. The mobile device of claim 1, wherein the spend limits and controls are managed in a spend control database.

6. The mobile device of claim 1, wherein the spend limits and controls are defined by a set of rules defined and managed by a rules engine.

7. The mobile device of claim 6, wherein the set of rules comprises business rules.

8. The mobile device of claim 1, wherein the payment card usage comprises current actual spend, a daily spend limit and a monthly spend limit.

9. The mobile device of claim 8, wherein the payment card usage is for a plurality of users.

10. The mobile device of claim 9, wherein the plurality of users comprise family members.

11. A method for applying token spend controls, the method comprising the steps of:
identifying, via a microprocessor, a payment card and a user device that is associated with the payment card;
generating a unique token based at least in part on the payment card and the user device;
identifying one or more spend limits and controls placed on the payment card that is specific to an authorized user of the payment card;
tracking the payment card usage by the authorized user;
generating and displaying, via an interactive user interface, the payment card usage; and
providing a notification when the payment card usage exceeds the one or more spend limits and controls.

12. The method of claim 11, wherein the spend limit comprises a dollar amount limit on spend for a predetermined time period.

13. The method of claim 12, wherein the predetermined time period comprises one of: one day, a week, and a month.

14. The method of claim 11, wherein the notification is communicated to one or more authorized recipients.

15. The method of claim 11, wherein the spend limits and controls are managed in a spend control database.

16. The method of claim 11, wherein the spend limits and controls are defined by a set of rules defined and managed by a rules engine.

17. The method of claim 16, wherein the set of rules comprises business rules.

18. The method of claim 11, wherein the payment card usage comprises current actual spend, a daily spend limit and a monthly spend limit.

19. The method of claim 18, wherein the payment card usage is for a plurality of users.

20. The method of claim 19, wherein the plurality of users comprise family members.
